(19) United States
(12) Patent Application Publication
(10) Pub. No.: US 2025/0122018 A1
(43) Pub. Date: Apr. 17, 2025

(54) FLEXIBLE MODULAR ASSEMBLY SYSTEM

(71) Applicant: Milara Incorporated, Milford, MA (US)

(72) Inventors: Krassimir D. PETKOV, Medway, MA (US); Velimir DERIC, Franklin, MA (US); George KRASTEV, Milford, MA (US); Radoslav A. KEFILEV, Chepelare City (BG); Sabin I. SINAPOV, Velingrad City (BG); Plamen KAMENAROV, Plovdiv (BG); Haniel OLIVERA, Fitchburg, MA (US)

(21) Appl. No.: 18/676,326

(22) Filed: May 28, 2024

Related U.S. Application Data
(63) Continuation of application No. 17/370,839, filed on Jul. 8, 2021, now abandoned.
(60) Provisional application No. 63/049,416, filed on Jul. 8, 2020.

(51) Int. Cl. B65G 15/22; B25J 9/02

(52) U.S. Cl. CPC B65G 15/22; B25J 9/026

(57) ABSTRACT

An automated manufacturing system that is flexible and scalable based on the needs of a manufacturing facility is provided. The manufacturing system includes one or more modular manufacturing units that are connected in series via a transport system. The modular manufacturing unit includes a base frame including a plurality of support members that are coupled to one or more feet; a main frame mounted on the base frame; a pair of opposed gantry support arms mounted on the main frame in a transverse direction, each gantry support arm including a rail; at least one gantry assembly slidably mounted across the rails of the gantry support arms in a longitudinal direction, each gantry assembly configured for performing a selected function or operation; and a transport system for conveying a device part through the modular manufacturing unit along the longitudinal direction for processing.

### RELATED APPLICATIONS

The present application is a continuation of non-provisional U.S. patent application Ser. No. 17/370,839 filed Jul. 8, 2021, entitled Flexible Modular Assembly System, which claims priority to U.S. provisional patent application Ser. No. 63/049,416, filed on Jul. 8, 2020, entitled Flexible Modular Assembly System, the contents of which are herein incorporated by reference.

### BACKGROUND OF THE INVENTION

Currently, the manufacture and assembly of consumer electronic devices, such as smart phones, is extremely labor intensive. Current manufacturing facilities employ thousands of workers to assemble the electronic devices. The workers have pre-defined tasks and are typically located at discrete stations throughout the assembly process. The pre-defined tasks often involve mounting or assembling a selected component of the device. Once this task is performed, the device is moved to the next station in the assembly process. This process is repeated until the device is fully assembled.

In modern day consumer electronic device manufacturing facilities, there is very little automation. The rapid changes in the design and features of consumer electronic devices year over year typically make it cost prohibitive for the manufacturing facilities to employ automated systems, such as robots, throughout the facility. As such, the manufacturing facilities rely on vast cadres of workers to assemble the devices. The labor intensive nature of the manufacturing and assembly process, however, results in high worker turnover. This places a tremendous burden on the manufacturing facilities to continually hire and train new workers for the facility.

Since many of the tasks associated with the assembly of the consumer devices are manual in nature, there are constant issues with regard to the inadvertent and unwanted introduction of contaminants into the devices during the assembly process. It is extremely difficult for the manufacturing facilities to address this issue because of the lack of automation.

Further, as the cost of wages continues to increase throughout the industrialized world, the cost of manufacturing and assembling the electronic devices continues to rise. As such, there is increasing pressure on the profitability of the manufacturing facilities.

### SUMMARY OF THE INVENTION

An object of the present invention is to design a manufacturing process that is at least in part automated.

Another object of the present invention is to design an automated process that is flexible and scalable based on the needs of the manufacturing facility.

The present invention is directed to an assembly system that is formed by a series of modular assembly units that are operatively coupled together and which can house or mount various assembly components. The modular assembly units can be changed or swapped in real time to meet the particular needs of the manufacturing and assembly facility. The ability to customize the overall assembly system by linking together a selected number of modular assembly units having selected assembly components contained therein or coupled thereto, so as to perform particular tasks, forms a flexible assembly system that is capable of meeting the changing and varied needs of modern day manufacturing and assembly facilities.

The present invention is directed to a modular manufacturing unit forming part of a manufacturing and assembly system. The modular manufacturing unit includes a base frame having a main body having a plurality of support members coupled at one end and a plurality of adjustable feet members coupled at an opposed end, and a main frame mounted on the base frame and coupled to and supported by the plurality of support members. The main frame and the base frame have a rectangular shape. The modular manufacturing unit further includes opposed first and second gantry support arms coupled to the main frame, where each of the first and second gantry support arms includes a main body forming an internal chamber and having a rail element mounted therein, and first and second movable gantry assemblies coupled to the first and second gantry support arms and spanning therebetween. Each of the first and second gantry assemblies has an elongated main body and includes a connection element formed at opposed ends of the main body, and the connection elements are configured to couple to the rail elements of the first and second gantry support arms. The first and second gantry assemblies are configured for lateral movement along the rail elements of the first and second gantry support arms, and each of the first and second gantry assemblies have one or more processing components coupled thereto for performing a selected processing function on a workpiece. The modular manufacturing unit also includes a transport system coupled to the main frame for conveying the workpiece in a longitudinal processing direction therethrough.

The first and second gantry assemblies are configured to be removably and replaceably coupled to the gantry support arms, and the main frame can be composed of a composite material. The main body of the first and/or second gantry assembly can include one or more additional connection elements for mounting the processing components to the main body. Further, the main body of the first and second gantry support arms is open at one or more ends to facilitate mounting and removal of the first and second gantry assemblies.

The assembly system of the present invention can also include a supply station coupled to one end of the main frame for supplying the workpiece to the transport system. The system can also employ an output stacker unit for storing the workpiece when exiting the main frame. Alternatively, the workpiece is conveyed to the transport system by a transport system of an adjacent upstream unit or the processed workpiece can be conveyed to a transport system of a downstream modular assembly unit.

According to the present invention, the first gantry assembly can be configured to perform a first selected processing operation on the workpiece and the second gantry assembly is configured to perform a second different processing operation on the workpiece. The first or second selected processing operations can include for example inspecting the workpiece, applying a material to the workpiece, and/or picking and placing the workpiece. According to one aspect, the material is a curable material and a curing station can be coupled to the main frame for curing the material after it is applied to the workpiece.

The present invention also contemplates providing one or more tape loaders that are coupled to the main frame for dispensing an adhesive tape to the workpiece during processing. The modular manufacturing unit can still further include a controller for controlling the transport system and the first and second gantry assemblies. The controller can include a configurable electronic circuit for performing one or more control operations, wherein the configurable electronic circuit includes an arbiter circuit for allocating access to shared resource and a frame and deframer element for communicating with one or more external controllers; a digital signal processor coupled to the configurable electronic circuit for processing one or more digital signals received therefrom; a processing element in communication with the configurable electronic circuit for receiving and processing signals therefrom, wherein the processing element includes one or more medium access control (MAC) controllers for controlling the flow of information and a display controller for controlling a display; and a first memory element coupled to the configurable electronic circuit for storing instructions and a second memory element coupled to the processing element for storing instructions.

The controller can be programmed with computer executable instructions executable by at least one computer processor to provide a user interface framework for developing a user interface to interact with one or more users; provide an automation interface framework that provides one or more automation interfaces for interfacing with one or more factory automation equipment; provide a business logic framework interacting with the user interface framework and with the automation interface framework that controls scheduling and sequencing of operations performed in the manufacturing system; provide a device control framework interacting with the business logic framework and the device control framework to facilitate control of the manufacturing system; and provide a vision system framework interacting with the business logic framework and the vision system framework so as to interact with one or more vision systems that are part of the manufacturing system. The plurality of modular manufacturing units are connected in series via the transport system.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a perspective view of the assembly system according to the present invention.

FIG. 2 is a perspective view of a modular assembly unit of the assembly system according to the teachings of the present invention.

FIG. 3 is a top view of the modular assembly unit of FIG. 2 according to the teachings of the present invention.

FIG. 4 is a schematic block diagram of a controller for use with the modular assembly unit according to the teachings of the present invention.

FIG. 5 is a schematic block diagram of the hierarchical structure of the controller of FIG. 4 and the modular assembly unit of FIG. 1 according to the teachings of the present invention.

FIG. 6 depicts components of the tool control software architecture of an exemplary embodiment of the present invention.

FIG. 7 depicts components of the assembly system and their relationships with the tool control software architecture according to the teachings of the present invention.

FIG. 8 provides an overview of components of the CCF software framework in an exemplary embodiment of the present invention.

FIG. 9 provides a view of the tool control software architecture illustrating how the CCF software framework may be employed.

FIG. 10 shows layers of the tool control software.

### DETAILED DESCRIPTION

The present invention is directed to an assembly system 10 that is formed by a series of modular assembly units 12 that can house or mount various assembly components. The assembly components can be same or can differ between the modular assembly units. The modular assembly units 12 forming the assembly system can be changed in real time to meet the particular needs of the manufacturing and assembly facility. The ability to customize the overall assembly system 10 by linking together a selected number of modular assembly units 12 having selected assembly components to perform particular, dedicated tasks forms a flexible assembly system 10 that is capable of meeting the changing and varying needs of modern day manufacturing and assembly facilities.

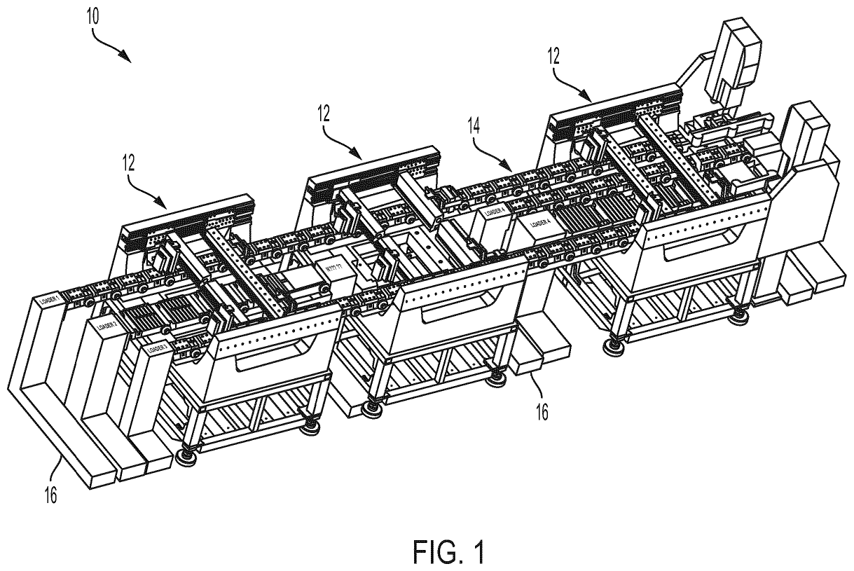

As shown for example in FIGS. 1-3, the present invention is directed to a manufacturing and assembly system 10 that is formed by a series of modular assembly units 12 that are operatively coupled together. The modular assembly units 12 preferably have similar or identical structural components while concomitantly mounting thereto specific process or assembly components that can be changed in real time based on the needs of the facility. Alternatively, the modular assembly units 12 can house or include different assembly components. The modular assembly units 12 can be disposed adjacent to each other or can be physically coupled together. The illustrated modular assembly units 12 can be coupled together for example by a transport system 14. The illustrated transport system 14 can include for example a conveyor assembly that transports or conveys selected device parts or components between the various modular assembly units 12. As is known in the art, the conveyor system can include one or more tracks that allow a component, workpiece, or item to move between the modular assembly units 12. Other processing or assembly components can be coupled to the assembly system 10 as the need arises. For example, one or more part supply stations 16 can be located so as to supply selected components to the system 10 during the assembly process or to collate or collect assembled components as they are completed by the particular modular assembly units 12. The part supply stations can include a housing forming an inner storage chamber for storing the components.

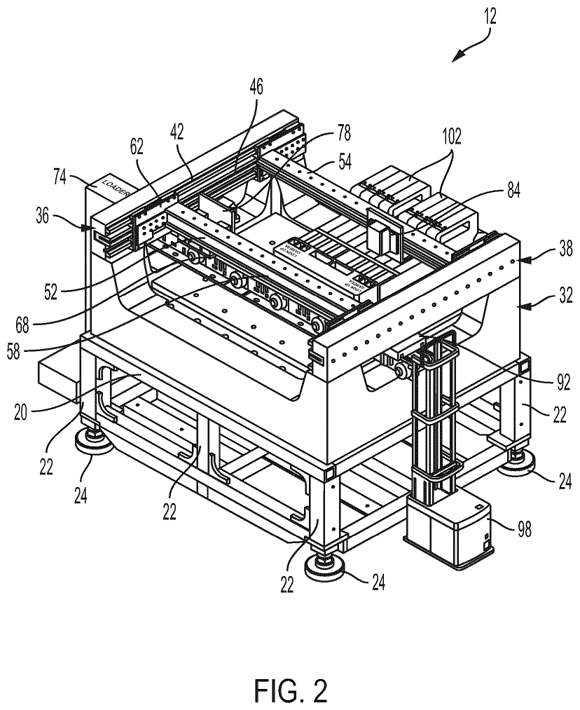

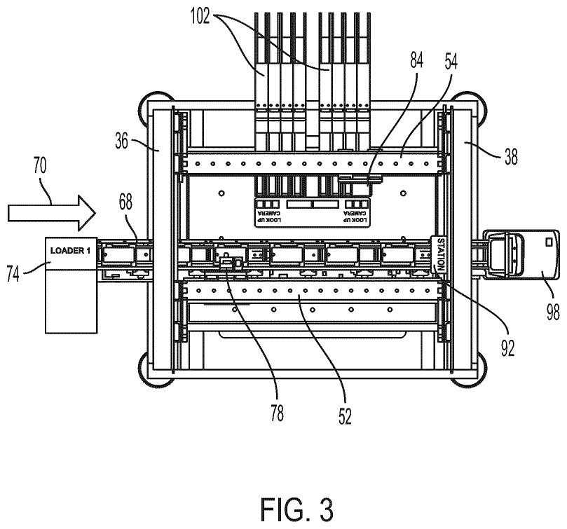

The modular assembly units 12 can have in general a similar design and construction. As shown in FIGS. 2 and 3, the illustrated modular assembly unit 12 includes a base frame 20. The illustrated base frame 20 includes a plurality of support members 22 that are coupled to a set of adjustable feet 26. The base frame 20 is intended to mount or seat a main frame 32. The main frame can be formed of any suitable material, and is preferably formed from a composite material. The main frame 32 is sized and configured to mount a pair of opposed gantry support arms 36, 38. The support arms 36, 38 can include a main housing 42 that forms a chamber that seats a rail element 46. The rail elements 46 and hence the support arms 36, 38 can mount one or more gantry assemblies for performing a selected function or operation. As shown, the illustrated modular assembly unit 12 mounts a pair of gantry assemblies 52, 54. The housing 42 of the support arms 36, 38 is preferably open at one or more ends, as shown, to allow for the easy removal or mounting of the gantry assemblies 52, 54. The gantry assemblies 52, 54 have an arm like main body 58 that has at each end a connection feature or element 62 that allows the gantry assembly to slidingly mount to the rails 46 of the support arms 36, 38. The main body 58 of the gantry assemblies 52, 54 can also have additional connection features or elements that allow or enable the mounting of additional processing or assembly components directly to the main body 58. As such, the gantry assemblies 52, 54 can be configured to mount any selected processing or assembly components suitable for the particular processing steps that are undertaken at the selected modular assembly unit 12. The transport system 14 is coupled to the illustrated modular assembly unit 12 and can include for example a conveyor system 68 for conveying a part or component through the modular assembly unit 12 for processing.

By way of example, if the modular assembly unit 12 of the assembly system 10 is configured to assemble or process particular components of a consumer electronic device, then the portion of the device to be processed is placed on the conveyor system 68. The part then travels along a travel path or processing direction 70 through the modular assembly unit 12. The part can be conveyed to the illustrated modular assembly unit 12 by the transport system 14 of an adjacent modular assembly unit, or can be supplied by a dedicated supply station, such as the load station 74. The load station 74 can be coupled to the modular assembly unit so as to supply components thereto. The components can be pre-fabricated or pre-processed components from anther modular assembly unit or can be new components that are to beaded to the product. The illustrated load station an have an outer housing that includes an inner chamber for storing the components. The load station can also have selected mechanical and electrical components for moving the components within the housing and for feeding or transferring the components to the conveyor system 68. The gantry assemblies 52, 54, which are oriented parallel to the travel path, can move along the rails 46 of the support arms 36, 38 in a transverse processing direction that is perpendicular to the travel path 70. The gantry assemblies 52, 54 can be configured to mount selected processing components sufficient to process the device part. For example, the gantry assembly 52 can have mounted thereto selected system processing components 78 that enable the gantry assembly to inspect the device part and to apply if needed any selected material, such as an adhesive or other bonding material, to the part. The second gantry 54 can also have mounted thereto additional processing system processing components 84 sufficient to pick and place the device part at selected locations on the conveyor system 68.

If desired, additional processing assemblies or systems can be coupled to the modular assembly unit 12 for further processing of the component part. For example, if the first gantry assembly 52 dispenses an adhesive, then a curing station 92 can be coupled to the unit 12 for curing the adhesive. The component part can exit the modular assembly unit 12 by being conveyed or transported to a downstream modular assembly unit 12, such as by the conveyor system 68, or can be placed in an output stacker or collector 98. If need be, additional processing stations can also be coupled to the illustrated modular assembly unit 12. For example, one or more tape loaders 102 can be coupled to the modular assembly unit 12. The tape loaders 102 can be configured to provide an adhesive tape that is applied if necessary to the component part during processing.

A significant advantage of the illustrated modular assembly units 12 is that the gantry assemblies 52, 54 are removable and replaceable, and hence each gantry assembly can be customized to mount selected processing components. This enables the manufacturing facility to customize the gantry assemblies, in real time, based on need so as to change the processing steps performed by the same modular assembly unit. This allows the facility to swap out gantry components in a customizable manner so as to form a flexible processing and assembly system.

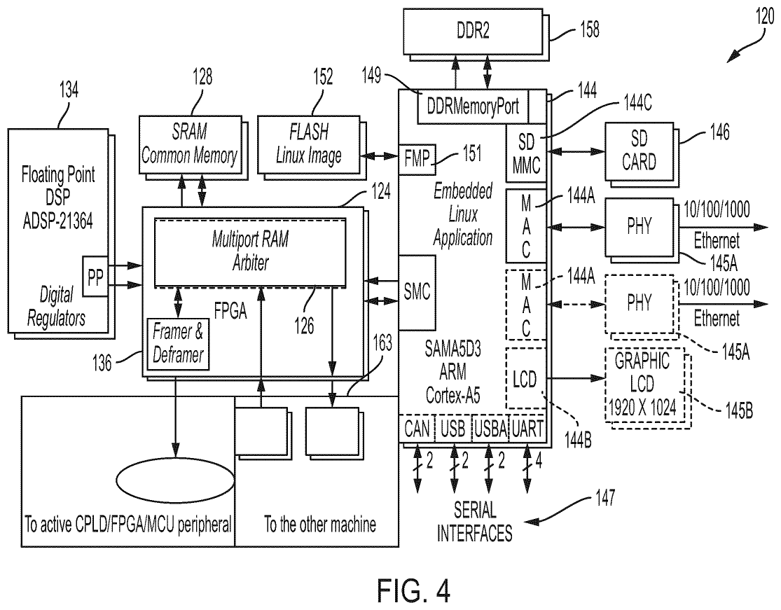

The modular assembly units 12 of the assembly system 10 can each have associated therewith a controller 120 for controlling one or more functions or parameters of the modular assembly unit 12 or for communicating with the controllers 120 of the other modular assembly units 12 of the assembly system 10, across any suitable network. As illustrated in FIG. 4, the controller 120 can include a configurable electronic circuit, such as a field programmable gate array (FPGA) element 124, that employs an arbiter circuit or device 126, such as a multiport RAM arbiter, for allocating access to shared resources. The FPGA element 124 is in bidirectional communication with a first memory element 128, such as an SRAM element. The FPGA element 124 is also in communication with a first processing element, such as for example with the digital signal processor 134. The digital signal processor 134 can be any suitable processing element, such as a floating point SHARC processor, that can include multiple processors.

The FPGA element 124 is also in bidirectional communication with a second processing element 144. The second processing element 144 can be any suitable processing element, and is preferably a SAMA5D3 ARM microprocessor chip from Atmel Corp. The second processing element 144 can also include one or more medium access control (MAC) controller Ethernet layer 144A that can be communicate with an associated physical layer (PHY) integrated circuits 145A that can be coupled to the MAC controller and is configured to implement the physical layer portion of the Ethernet by implementing and controlling the transmission of data thereacross; a display controller, such as a liquid crystal display (LCD) controller 144B, that can be coupled to a graphic integrated circuit 145B for controlling a display; a secure digital (SD) or multiple media card port or slot 144C for mounting a SD or MMC card 146; one or more serial interfaces 147 including a universal serial bus (USB) interface, a universal asynchronous receiver transmitter (UART) interface, and the like; and other suitable connections, including for example to a second memory element 158, such as a double data rate (DDR2) dynamic random access memory element. The illustrated external second memory element 158 is in bidirectional communication with the second processing element 144 via a memory port 149. Further, the second processing element 144 can further communicate with a third memory element 152. The third memory element 152 can be any suitable memory element and preferably is a flash memory element. The third memory element 152 is coupled to the processing element 144 by a flash memory protection (FMP) interface 151 and can store an operating system for the controller 120, such as Linux, and an associated application (e.g., a Linux application) to run the controller 120.

The FPGA element 124 can be further disposed in bidirectional communication 163 with another FPGA, such as for example with a complex programmable logic device (CPLD), a microcontroller unit (MCU), another machine, or any combinations thereof. In some embodiments, the modular assembly unit 12 can be in bidirectional communication with another modular assembly unit 12 through the FPGA element equipped in each unit. In such embodiments, the FPGA elements 124 can communicate with one another through a framer/deframer 136 that functions to frame or package information into packets.

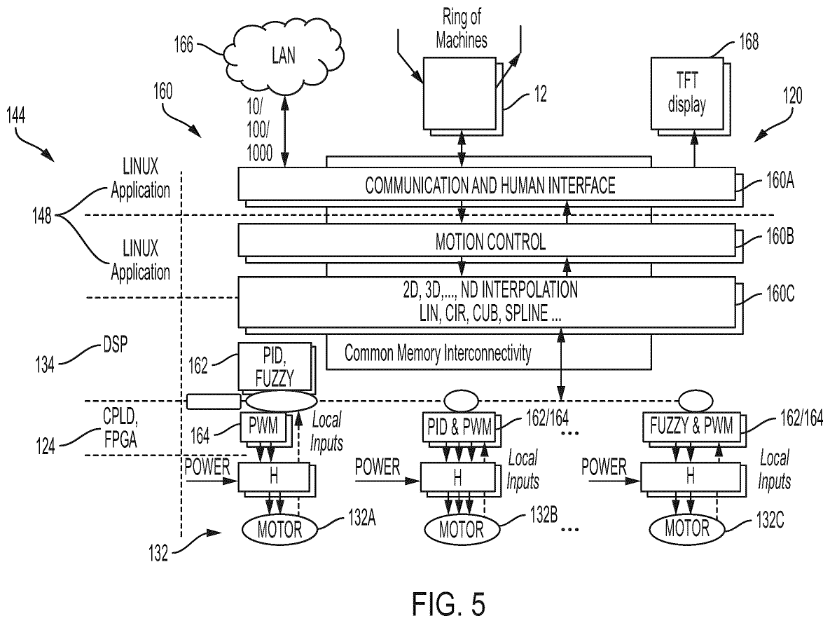

Those of ordinary skill in the art will readily recognize that the illustrated controller 120 can be formed with different electrical components or have a different arrangement of components. The illustrated controller 120 of the present invention can bifurcate in a parallel processing manner selected tasks so as to increase the overall processing speed of the controller. According to one practice, as shown in FIG. 5, the controller 120 can be used to control the movement or motion of selected components of the modular assembly unit 12, such as for example a series of motors, including for example motors 132A, 132B, and 132C, the gantry arms, processing elements, and the like. Specifically, the controller via the FPGA element 124 can employ a control algorithm, such as for example a proportional-integral-derivative (PID) and associated fuzzy logic technique 162, along with a pulse width modulation (PWM) logic technique 164, to control the motors 132. The PID technique 162 is a feedback control technique that helps the controller control the motors 132, and the fuzzy logic is a known technique that helps control processes represented by subjective, linguistic descriptions.

The logical hierarchy 160 can also include a higher level communication and interface logic layer 160A for allowing the user to interact with the system. The communication and interface logic layer 160A can interact with the user through any suitable wired or wireless connection via a network, such as a local area network 166. The communication and interface logic layer 160A can thus interact with a series or ring of the modular assembly units 12 as well as one or more displays, such as the thin film transistor (TFT) display. In turn, the communication and interface logic layer 160A can communicate with the motion control logic layer 160B. The motion control logic layer 160B implements via suitable hardware and software the control functions of the overall system 10. The control functions can include controlling the gantry assemblies 52, 54, the motors 132, the processing hardware associated with the modular assembly units 12, and the like. The motion control logic layer 160B can in turn be coupled to the interpolation layer 160C of the logical hierarchy 160. The interpolation layer 160C can interpolate instructions passing through the system for subsequent communication with the motors using the PID and PWN techniques. In practice, the hardware structure of the controller 120 shown in FIG. 4 can operate with the logical hierarchy 160 as shown in FIG. 5. By way of example, the second processing element 144 that runs the embedded Linux applications 148 can control the motors 132A, 132B, and 132C and the like through the FPGA element 124, which is provided with one or more digital signal processors (DSPs) 134. The FPGA element 124 of the illustrated controller 120 can communicate with other networked controllers 120 associated with other modular assembly units 12 of the assembly system 10 through any suitable interface.

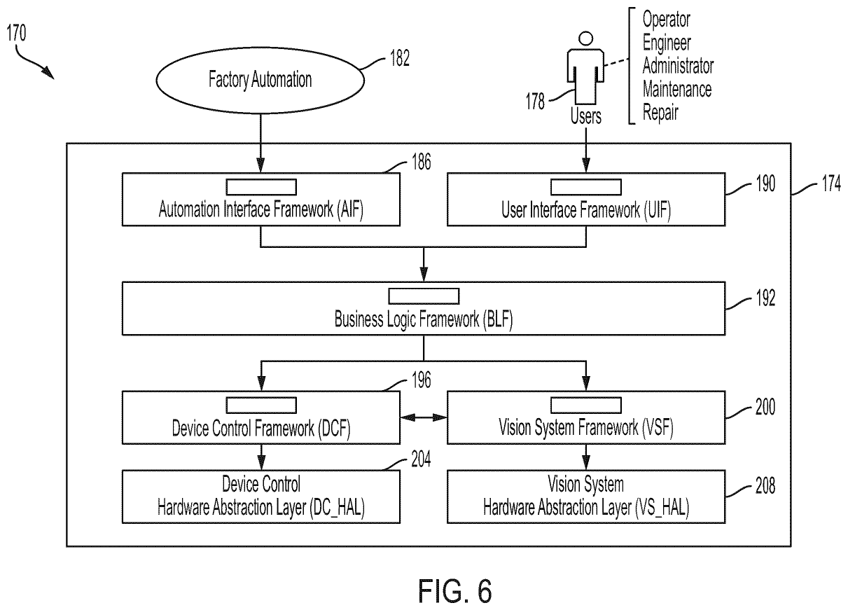

FIG. 6 shows a tool control software architecture 170 that is suitable for use with the illustrated manufacturing assembly system 10 that employs a series of modular assembly units 12. The tool control software architecture 170 can be implemented by the controller 120 of the present invention. The tool control software architecture 170 can be embodied and implemented in the illustrated hardware components, or by any suitable hardware, such as by known electronic devices (e.g., computers, servers, processors, memory, and the like) that are coupled to the controller 120. Those skilled in the art will readily appreciate that the illustrated software architecture 170 is intended to be merely illustrative and not limiting of the present invention. The tool control software architecture 170 facilitates a software framework or a software development framework that is intended to be hardware independent, user interface independent and factory interface independent. The tool control software developed in correspondence with this software architecture is intended to be independent of any motion control system that may be used. The tool control software architecture 170 is configured to work with different devices and processes and is reusable and adaptable for use with different product lines. Thus, the tool control software architecture 170 can accommodate changes to product lines, changes in the configuration of the modular assembly units 12, and changes in associated tools, processing components and configurations. As is known in computer programming, a software framework is an abstraction in which software, which provides generic functionality, can be selectively modified by additional user-written code, thus providing application-specific software. The framework can provide a standard way to build and deploy applications in the assembly system of the present invention. The software framework can include support programs, compilers, code libraries, toolsets, and application programming interfaces (APIs) that bring together all the different components to enable development of a project or system.

The tool control software architecture 170 includes a number of software components or layers 174. The illustrated software component 174 can include for example a user interface framework 190 that provides a framework for developing a user interface to interact with users 178 and any associated displays, such as the display 168. An automation interface framework 186 provides automation interfaces for interfacing with factory automation equipment 182, such as the modular assembly units 12 and associated processing components. The tool control software architecture 170 can also include a business logic framework 192 that contains the business logic for controlling operation of the modular assembly units 12 of the manufacturing and assembly system 10 of the present invention. The business logic framework 192 may control for example the scheduling and sequencing of tools and operations performed in the manufacturing and assembly system. The business logic framework 192 may also include additional functionality not itemized herein. The business logic framework 192 interacts with the device control framework 196 and the vision system framework 200. The device control framework 196 is designed to facilitate control of devices of the manufacturing and assembly system. The vision system framework 200 interacts with any vision system that is part of the manufacturing and assembly system. The device control framework 196 includes a device control hardware abstraction layer 204. The device control hardware abstraction layer 204 abstracts away the specific characteristics of the devices and allows the software framework to be developed that is independent of the specific devices. The device control hardware abstraction layer 204 may include various drivers that are designed to interact with specific processing components and devices (e.g., printers, curing apparatus, adhesive application devices, sintering devices, loading devices, motors, controllers, and the like). The vision system framework 200 can include a vision system hardware abstraction layer 208. The vision system hardware abstraction layer 208 abstracts away the various device dependencies of elements of the vision system in the manufacturing and assembly system. The vision system hardware abstraction layer 208 may include drivers that are specific to vision system elements.

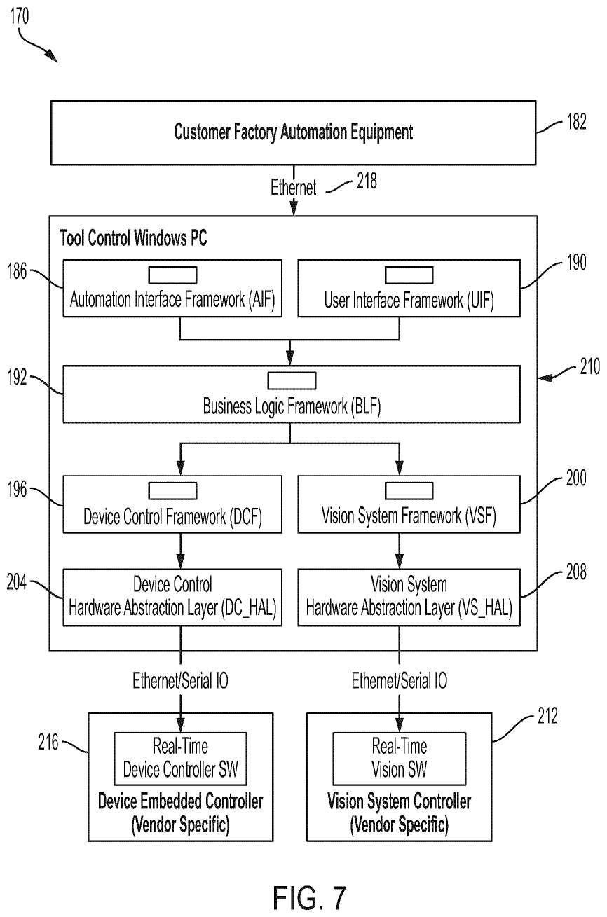

FIG. 7 illustrates how the tool control software architecture 170 of the present invention fits into various components contained in the manufacturing and assembly system 10 of the present invention. The tool control software architecture may reside on a computer system 210, such as for example a personal computer or workstation, that has various network connections, such as Ethernet connections, or serial IO connections, processors, memory, storage and the like. As shown in FIG. 7, the factory automation equipment 182 interfaces with the computer system 210 via a suitable network connection 218, such as for example an Ethernet connection. The computer system 210 also interfaces with embedded device controllers 216 of particular devices and vision system controllers 212 on particular vision system elements. Real time software may reside on the respective controllers.

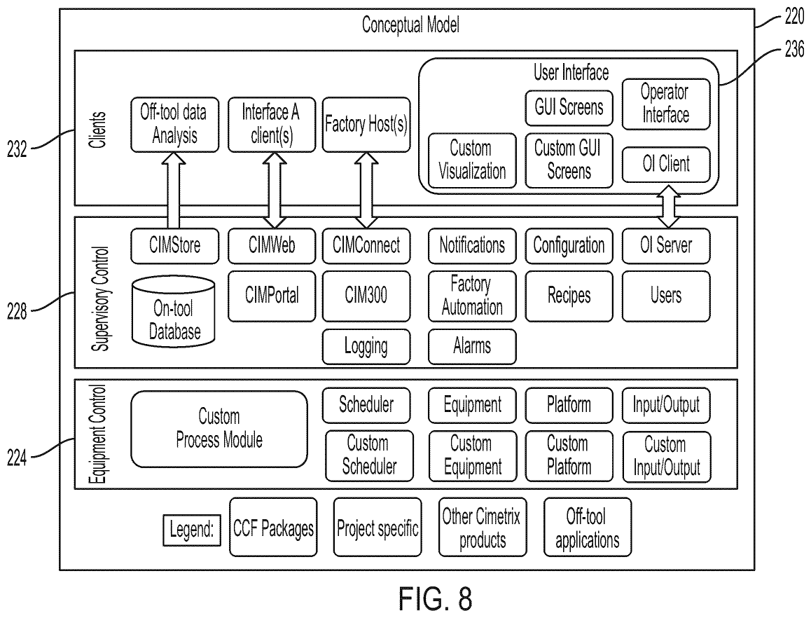

In an exemplary embodiment of the present invention described herein, the tool control software architecture 170 leverages an existing software framework. In particular, the architecture 170 can leverage for example the Cimetrix CCF software framework, sold by Cimetrix Incorporated. As shown in FIG. 8, the conceptual model 220 of the Cimetrix CCF software framework includes an equipment control component or layer 224, a supervisory control component or layer 228 and numerous clients 232. A user interface framework 236 is also provided.

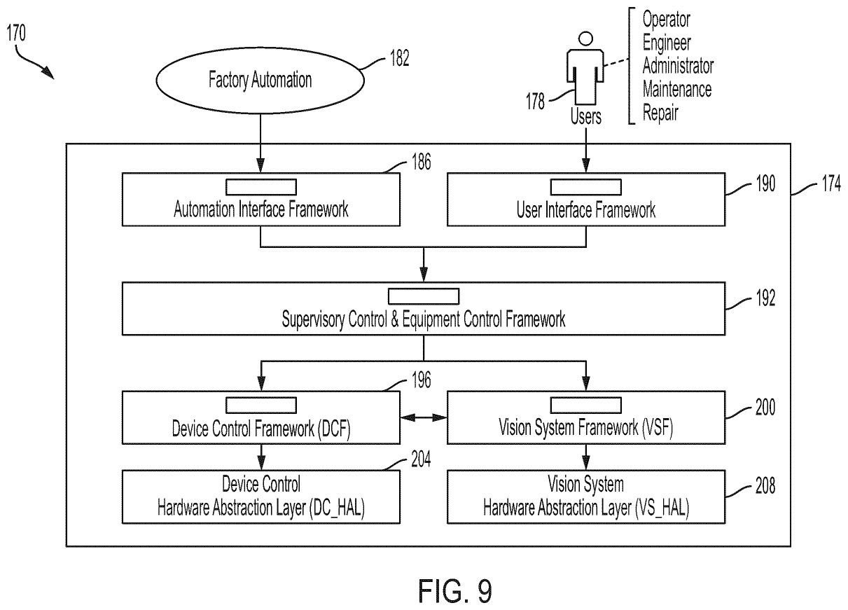

FIG. 9 illustrates how the conceptual model 220 of the Cimetrix CCF framework may be leveraged in the illustrative embodiment. As can be seen in FIG. 9, the factory automation framework 186, the user interface framework 190, and the supervisory control and control equipment control framework 192 are leveraged from the Cimetrix CCF framework. The remaining custom developed components 196, 200, 204 and 206 supplement the framework in the illustrative embodiment.

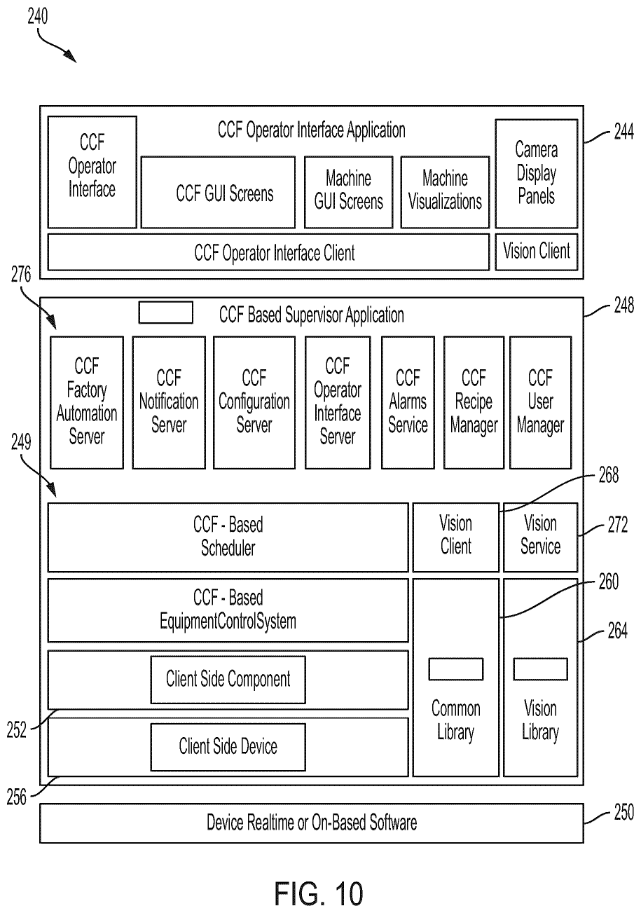

FIG. 10 shows the tool control software layers 240 in further detail. The tool control software layers 240 include an operator interface application 244 for interfacing with an operator of the manufacturing and assembly system 10, a supervisor application 248 for performing supervisory activities and device real time or on-board software 250. Of particular interest is the type and number of software objects 249 contained within the supervisory application 248. The software objects 249 include the client side device objects 256 (“device objects”) that represent hardware devices. Also included are a client side component object 252 that act as component wrappers for the devices objects. The common library 260 provides services, classes and data types that can be used to maintain commonality between various tool control software implementations. A vision library 264 is provided to include a library of objects that are specific to the vision system. The vision client 268 and the vision service 272 are provided as part of the supervisor application 248.

As was mentioned above, the client side device objects 256 are each a representation of a device and are typically implemented as a stand alone library, such as a dynamic link library, that the supervisory application 248 calls to control/monitor a particular device. Each device object serves as a wrapper to particular implementation of such device by a respective vendor. Each device object is intended to isolate vendor specific variations in commands, events, responses and the like from the supervisor application 248 by creating a generic interface for the device. The supervisor application 248 can also include a number of servers 276 for implementing factory automation, notification, configuration, alarm, and management services.

The library of device objects is expandable and can be supplemented to include objects for additional devices. The library of device objects enables the manufacturing and assembly system to accommodate changes in devices that are included in the manufacturing and assembly system. Tools may be swapped in and out, and the entire manufacturing and assembly system may be retooled to accommodate a different product line.

What is claimed is:

1. A modular manufacturing unit forming part of a manufacturing and assembly system, comprising:
a base frame having a main body having a plurality of support members coupled at one end and a plurality of adjustable feet members coupled at an opposed end, the base frame having a rectangular shape,
a main frame mounted on the base frame and coupled to and supported by the plurality of support members, the main frame having a rectangular shape,
opposed first and second gantry support arms coupled to the main frame, wherein each of the first and second gantry support arms includes a main body forming an internal chamber and having a rail element mounted therein,
first and second movable gantry assemblies coupled to the first and second gantry support arms and spanning therebetween, wherein each of the first and second gantry assemblies has an elongated main body and includes a connection element formed at opposed ends of the main body, wherein the connection elements are configured to couple to the rail elements of the first and second gantry support arms, and wherein the first and second gantry assemblies are configured for lateral movement along the rail elements of the first and second gantry support arms, and wherein each of the first and second gantry assemblies have one or more processing components coupled thereto for performing a selected processing function on a workpiece; and
a transport system coupled to the main frame for conveying the workpiece in a longitudinal processing direction therethrough,
wherein the first and second gantry assemblies are configured to be removably and replaceably coupled to the gantry support arms, and
wherein the main body of the first and second gantry support arms is open at one or more ends to facilitate mounting and removal of the first and second gantry assemblies.

2. The modular manufacturing unit of claim 1, wherein the main frame is composed of a composite material.

3. The modular manufacturing unit of claim 2, wherein the main body of the first or second gantry assembly comprises one or more additional connection elements for mounting the processing components to the main body.

4. The modular manufacturing unit of claim of claim 1, further comprising a supply station coupled to one end of the main frame for supplying the workpiece to the transport system.

5. The modular manufacturing unit of claim 1, wherein the workpiece is conveyed to the transport system by a transport system of an adjacent upstream unit.

6. The modular manufacturing unit of claim 1, wherein the workpiece is conveyed by the transport system to an output stacker unit for storing the workpiece.

7. The modular manufacturing unit of claim 1, wherein the workpiece is conveyed by the transport system to a transport system of an adjacent downstream modular assembly unit.

8. The modular manufacturing unit of claim 3, wherein the first gantry assembly is configured to perform a first selected processing operation on the workpiece and the second gantry assembly is configured to perform a second different processing operation on the workpiece.

9. The modular manufacturing unit of claim 8, wherein the first or second selected processing operation includes at least one of inspecting the workpiece, applying a material to the workpiece, and picking and placing the workpiece.

10. The modular manufacturing unit of claim 9, wherein the material is a curable material, and further comprising a curing station coupled to the main frame for curing the material applied to the workpiece.

11. The modular manufacturing unit of claim 8, further comprising a plurality of tape loaders coupled to the main frame for dispensing an adhesive tape that is applied to the workpiece during processing.

12. The modular manufacturing unit of claim 8, further comprising a controller for controlling the transport system and the first and second gantry assemblies.

13. The modular manufacturing unit of claim 12, wherein the controller comprises
a configurable electronic circuit for performing one or more control operations, wherein the configurable electronic circuit includes an arbiter circuit for allocating access to shared resource and a frame and deframer element for communicating with one or more external controllers,
a digital signal processor coupled to the configurable electronic circuit for processing one or more digital signals received therefrom,
a processing element in communication with the configurable electronic circuit for receiving and processing signals therefrom, wherein the processing element includes one or more medium access control (MAC) controllers for controlling the flow of information and a display controller for controlling a display, and
a first memory element coupled to the configurable electronic circuit for storing instructions and a second memory element coupled to the processing element for storing instructions.

14. The modular manufacturing unit of claim 12, wherein the controller is programmed with computer executable instructions executable by at least one computer processor to
provide a user interface framework for developing a user interface to interact with one or more users;
provide an automation interface framework that provides one or more automation interfaces for interfacing with one or more factory automation equipment;
provide a business logic framework interacting with the user interface framework and with the automation interface framework that controls scheduling and sequencing of operations performed in the manufacturing system;
provide a device control framework interacting with the business logic framework and the device control framework to facilitate control of the manufacturing system; and
provide a vision system framework interacting with the business logic framework and the vision system framework so as to interact with one or more vision systems that are part of the manufacturing system.

15. A manufacturing system comprising a plurality of modular manufacturing units, each according to claim 1, wherein the plurality of modular manufacturing units are connected in series via the transport system.

16. A modular manufacturing unit forming part of a manufacturing and assembly system, comprising:
a base frame having a main body having a plurality of support members coupled at one end and a plurality of adjustable feet members coupled at an opposed end, the base frame having a rectangular shape,
a main frame mounted on the base frame and coupled to and supported by the plurality of support members, the main frame having a rectangular shape,
opposed first and second gantry support arms coupled to the main frame, wherein each of the first and second gantry support arms includes a main body forming an internal chamber and having a rail element mounted therein,
first and second movable gantry assemblies coupled to the first and second gantry support arms and spanning therebetween, wherein each of the first and second gantry assemblies has an elongated main body and includes a connection element formed at opposed ends of the main body, wherein the connection elements are configured to couple to the rail elements of the first and second gantry support arms, and wherein the first and second gantry assemblies are configured for lateral movement along the rail elements of the first and second gantry support arms, and wherein each of the first and second gantry assemblies have one or more processing components coupled thereto for performing a selected processing function on a workpiece; and
a transport system coupled to the main frame for conveying the workpiece in a longitudinal processing direction therethrough,
wherein the first gantry assembly is configured to perform a first selected processing operation on the workpiece and the second gantry assembly is configured to perform a second different processing operation on the workpiece,
wherein the first or second selected processing operation includes at least one of inspecting the workpiece, applying a material to the workpiece, and picking and placing the workpiece, and
wherein the material is a curable material, and further comprising a curing station coupled to the main frame for curing the material applied to the workpiece.

17. A modular manufacturing unit forming part of a manufacturing and assembly system, comprising:
a base frame having a main body having a plurality of support members coupled at one end and a plurality of adjustable feet members coupled at an opposed end, the base frame having a rectangular shape,
a main frame mounted on the base frame and coupled to and supported by the plurality of support members, the main frame having a rectangular shape,
opposed first and second gantry support arms coupled to the main frame, wherein each of the first and second gantry support arms includes a main body forming an internal chamber and having a rail element mounted therein,
first and second movable gantry assemblies coupled to the first and second gantry support arms and spanning therebetween, wherein each of the first and second gantry assemblies has an elongated main body and includes a connection element formed at opposed ends of the main body, wherein the connection elements are configured to couple to the rail elements of the first and second gantry support arms, and wherein the first and second gantry assemblies are configured for lateral movement along the rail elements of the first and second gantry support arms, and wherein each of the first and second gantry assemblies have one or more processing components coupled thereto for performing a selected processing function on a workpiece; and
a transport system coupled to the main frame for conveying the workpiece in a longitudinal processing direction therethrough,
a controller for controlling the transport system and the first and second gantry assemblies,
wherein the controller includes:
a configurable electronic circuit for performing one or more control operations, wherein the configurable electronic circuit includes an arbiter circuit for allocating access to shared resource and a frame and deframer element for communicating with one or more external controllers,
a digital signal processor coupled to the configurable electronic circuit for processing one or more digital signals received therefrom,
a processing element in communication with the configurable electronic circuit for receiving and processing signals therefrom, wherein the processing element includes one or more medium access control (MAC) controllers for controlling the flow of information and a display controller for controlling a display, and
a first memory element coupled to the configurable electronic circuit for storing instructions and a second memory element coupled to the processing element for storing instructions.

19. A modular manufacturing unit forming part of a manufacturing and assembly system, comprising:
a base frame having a main body having a plurality of support members coupled at one end and a plurality of adjustable feet members coupled at an opposed end, the base frame having a rectangular shape,
a main frame mounted on the base frame and coupled to and supported by the plurality of support members, the main frame having a rectangular shape,
opposed first and second gantry support arms coupled to the main frame, wherein each of the first and second gantry support arms includes a main body forming an internal chamber and having a rail element mounted therein,
first and second movable gantry assemblies coupled to the first and second gantry support arms and spanning therebetween, wherein each of the first and second gantry assemblies has an elongated main body and includes a connection element formed at opposed ends of the main body, wherein the connection elements are configured to couple to the rail elements of the first and second gantry support arms, and wherein the first and second gantry assemblies are configured for lateral movement along the rail elements of the first and second gantry support arms, and wherein each of the first and second gantry assemblies have one or more processing components coupled thereto for performing a selected processing function on a workpiece; and
a transport system coupled to the main frame for conveying the workpiece in a longitudinal processing direction therethrough,
a controller for controlling the transport system and the first and second gantry assemblies,
wherein the controller is programmed with computer executable instructions executable by at least one computer processor to:
provide a user interface framework for developing a user interface to interact with one or more users;
provide an automation interface framework that provides one or more automation interfaces for interfacing with one or more factory automation equipment;
provide a business logic framework interacting with the user interface framework and with the automation interface framework that controls scheduling and sequencing of operations performed in the manufacturing system;
provide a device control framework interacting with the business logic framework and the device control framework to facilitate control of the manufacturing system; and
provide a vision system framework interacting with the business logic framework and the vision system framework so as to interact with one or more vision systems that are part of the manufacturing system.
